(19) United States
(12) Patent Application Publication
(10) Pub. No.: US 2022/0332617 A1
(43) Pub. Date: Oct. 20, 2022

(54) WATER TREATMENT PLANT WITH HEAT TRANSFER MEANS AND RELATED METHOD

(71) Applicant: ROBERT SINCLAIR, WINNIPEG (CA)

(72) Inventor: ROBERT SINCLAIR, WINNIPEG (CA)

(21) Appl. No.: 17/671,842

(22) Filed: Feb. 15, 2022

Related U.S. Application Data
(60) Provisional application No. 63/159,686, filed on Mar. 11, 2021.

(51) Int. Cl. C02F 9/00

(52) U.S. Cl. CPC C02F 9/00; C02F 1/52

(57) ABSTRACT

A water treatment plant and related method of water treatment comprise a treatment stage including a partial-treatment substage configured to apply at least one of chemical and physiochemical processes for reducing contaminants in the water, a preliminary filtration substage configured to remove large contaminants in the water such as microorganisms and pathogens, and a secondary filtration substage comprising one or more selectively permeable membranes configured to remove remaining contaminants which may include organic micro-organisms and ionic sized inorganic matter from the water. The plant also includes a heat transfer assembly configured to extract heat from water downstream of the treatment stage and to input the heat to water to be treated upstream of at least the secondary filtration substage, so as to recycle heat in the water within the plant to increase a treatment rate or reduce the power consumption of at least the secondary filtration substage.

This application claims the benefit under 35 U.S.C. 119(e) of U.S. Provisional App. Ser. No. 63/159,686 filed Mar. 11, 2021.

### FIELD OF THE INVENTION

The present invention relates generally to a water treatment plant or facility and related water treatment method, and more particularly to such a plant or facility having heat recycling means to transfer heat from one location or stage in a treatment process to another location or stage to improve the treatment process, and related method of water treatment.

### BACKGROUND

Water treatment becomes challenging in cold climates due to a temperature of influent water to a treatment plant. Most processes performed in such a facility are temperature dependent on the water passing therethrough. Thus, when the water to be treated is of a relatively low temperature chemical processes are inhibited and consume more treatment chemicals while the increased viscosity of cold water slows coagulation and settling processes thus requiring larger settling clarifiers and for membrane processes, now a major component of water treatment facilities, increased viscosity reduces the flow through the membrane and increases the power requirements for design flows. The table below presents the treatment changes with temperature for reverse osmosis membranes from 4° C. to 25° C., the treatment flow capacity increases by approximately 300%. From 4° C. to 38° C., the treatment flow capacity increases by a little more than 400%. These treatment improvements with temperature are very significant and would greatly extend the life of an older system nearing its ultimate treatment capacity and would significantly reduce the size of the membrane system for a new facility.

TABLE 1
Temperature Correction Factors for Reverse Osmosis Systems
Temperature Correction

| Temperature (Fahrenheit/Celsius) | Correction Factor |
|---|---|
| 40/4 | 0.34 |
| 50/10 | 0.52 |
| 60/16 | 0.7 |
| 70/21 | 0.88 |
| 77/25 | 1 |
| 80/27 | 1.05 |
| 90/32 | 1.23 |
| 100/38 | 1.41 |

### SUMMARY OF THE INVENTION

According to an aspect of the invention there is provided a water treatment plant comprising:

an input configured for receiving water for treatment;

an output configured for discharging water after treatment, wherein the output comprises a sewer output configured for discharging contaminated water to sewer and a user output configured for discharging treated water for consumption;

wherein a flow of water is defined by the input and the output;

a treatment stage between the input and the output and configured for reducing contaminants in the water, wherein the treatment stage is configured to form treated water, which is substantially free from contaminants, and contaminated water;

wherein the treatment stage includes:
a partial-treatment substage configured for applying at least one of chemical and physiochemical processes to reduce the contaminants in the water;
a preliminary filtration substage configured for reducing contaminants including at least one of microorganisms, pathogens and particulate nonliving matter;
a secondary filtration substage downstream from the preliminary filtration substage, relative to the flow of water, and comprising a selectively permeable membrane configured for mechanically removing substantially all remaining contaminants not removed by the partial-treatment or preliminary filtration substages;

a distribution storage stage between the treatment stage and the user output and configured for storing treated water; and

a heat transfer assembly configured for extracting heat from water downstream from the treatment stage and inputting the extracted heat upstream from the secondary filtration substage.

This provides an arrangement for extracting heat from strategic locations in a water treatment plant and recycling the heat at an input to a treatment substage, particularly before treatment at the secondary filtration substage, to improve performance of the membrane process thereof but also the entire treatment process. This recycling of heat will also reduce power consumption for pumping water through one or more of the filtration substages and increase a processing rate of the treatment process.

In one arrangement, the heat transfer assembly is configured to input the extracted heat upstream of the preliminary filtration stage.

In one arrangement, the heat transfer assembly is configured to input the extracted heat upstream of the treatment stage. Thus, all constituent processes of the treatment stage may benefit from the increased temperature of the water.

In one arrangement, the heat transfer assembly is configured to input the extracted heat immediately downstream of the input.

In one arrangement, the heat transfer assembly is configured to extract heat downstream from the distribution storage stage.

In one arrangement, the heat transfer assembly is configured to extract heat from the treated water and the contaminated water.

In one arrangement, the heat transfer assembly comprises a heat transfer loop configured to transport heat using a circulating heat-transfer fluid and wherein the heat transfer loop comprises a first branch configured to extract heat from the treated water and a second branch configured to extract heat from the contaminated water, and wherein the heat transfer assembly is configured to circulate heat-transfer fluid at a higher flow rate through the first branch than through the second branch.

In one arrangement, a ratio of flow rates of heat-transfer fluid through the first branch and the second branch is greater than or about equal to a ratio of volumes of treated water and contaminated water leaving the treatment stage.

In one arrangement, the ratio of flow rates of heat-transfer fluid through the first branch and the second branch is greater than or about 3:1.

According to another aspect of the invention there is provided a method for treating water comprising:

applying one or more chemical or physiochemical processes to partially treat the water;

filtering the water to reduce contaminants including at least one of microorganisms, pathogens and particulate matter;

after filtering the water to reduce at least one of microorganisms, pathogens and particulate matter, filtering the water to remove substantially all remaining contaminants;

whereby separate flows of treated water and contaminated water are formed;

temporarily storing the treated water;

discharging the treated and contaminated waters; and

before discharging the treated and contaminated waters, extracting heat therefrom and inputting the heat to the water before filtering the water to remove organic and inorganic matter.

### BRIEF DESCRIPTION OF THE DRAWINGS

The invention will now be described in conjunction with the accompanying drawings in which:

FIG. 1 is a schematic diagram of an arrangement of water treatment plant according to the present invention.

In the drawings like characters of reference indicate corresponding parts in the different figures.

### DETAILED DESCRIPTION

In the accompanying figure there is shown a water treatment plant 10 for treating surface water, such as freshwater, or ground water to be used for user consumption, for example specifically for drinking, which includes a heat transfer assembly 12 configured to recycle heat from water flowing through the plant from one location or stage in a treatment process carried out therein to another location or stage in order to improve the treatment process. In general, the water treatment plant 10 forms potable water.

The water treatment plant generally comprises an input 14 configured for receiving water for treatment which is generally untreated, for example by fluidic coupling, normally a pump, so as to be in fluidic communication with a source of water 1; and an output 16 configured for discharging water after treatment including a sewer output 17A configured for discharging contaminated water to sewer, for example by fluidic coupling, mainly by gravity so as to be in fluidic communication with sewer or waste collection 3, and a user output 17B configured for discharging treated water for consumption, for example by fluidic coupling so as to be in fluidic communication with a water transmission or distribution system 4. The input and output 14, 16 define a flow of water through the plant in a direction from the input 14 to the output 16. The water received into the plant 10 may be termed in industry as raw inflow and that discharged from the plant 10 may be termed as treated outflow.

Additionally, the plant 10 comprises a treatment stage 20 between the input 14 and the output 16 and configured for reducing contaminants in the water. The treatment stage 20 is thus configured to form treated water, which is substantially free from contaminants, and contaminated water, which contains the contaminants excluded from the treated water. The treatment stage 20 receives untreated water for treatment.

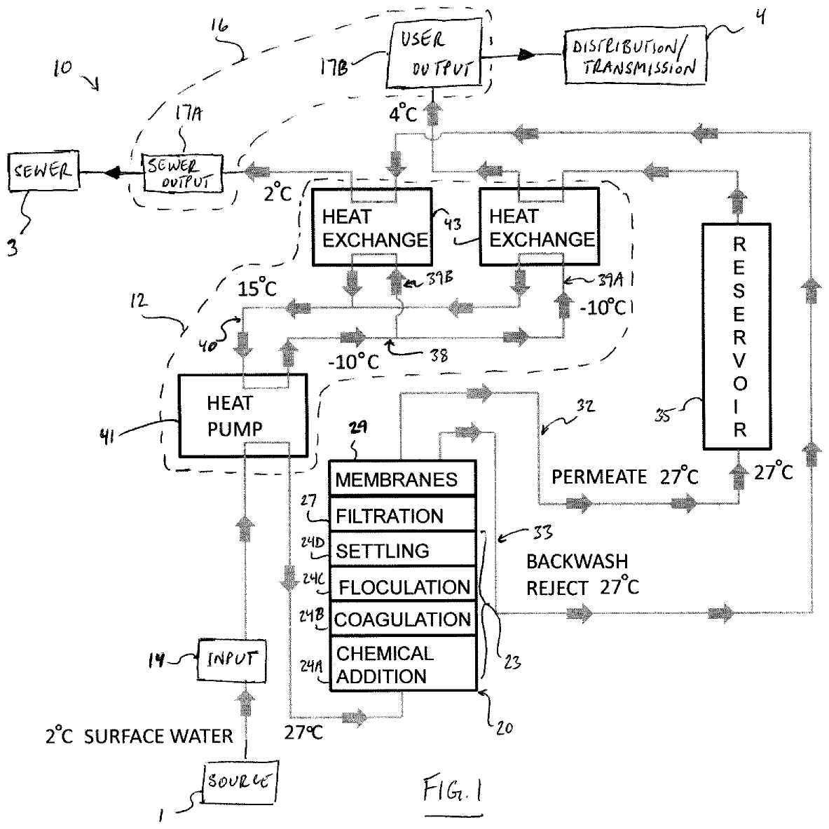

More specifically, the treatment stage 20 includes a partial-treatment substage 23 configured for applying at least one of chemical and physiochemical processes to reduce the contaminants in the water. In other words, the partial treatment substage 23 may include one or more chemical or physiochemical process, for example a series of processes such as clarifying agent addition substage 24A (which may be generically referred to as a chemical addition substage as in FIG. 1), a coagulation substage 24B, and a flocculation substage 24C. In the illustrated arrangement, the partial-treatment substage 23 also includes a physical process substage in the form of a settling substage 24D. Furthermore, in the illustrated arrangement, the partial-treatment substage 23 is a preliminary or initial substage of the overall water treatment stage 20. The partial-treatment substage 23 forms partially treated water containing fewer contaminants than the water upstream thereof and suitable for further treatment to substantially remove the remaining, although reduced level, of waterborne contaminants.

The treatment stage 20 further includes a preliminary filtration substage 27 configured for reducing contaminants including at least one of microorganisms, pathogens and particulate nonliving matter, for example that which cause turbidity, such as suspended solids and algae. In other words, the preliminary filtration substage 27 is an initial mechanical or physical filtration substage configured for generally coarse filtration of the partially treated water. Preferably, at the preliminary filtration substage all of the group consisting of microorganisms, pathogens and particulate matter are substantially removed.

Further to the preliminary filtration substage 27 there is provided a secondary filtration substage 29 of the treatment stage 20, downstream from the preliminary filtration substage 27 relative to the flow of water through the plant, which comprises a system of one or more selectively permeable membranes configured for mechanically removing substantially all remaining contaminants not removed by the partial-treatment or preliminary filtration substages. This generally includes, at minimum, organic and inorganic matter such as dissolved mineral contaminant species for example sodium and chloride (salt), mercury, arsenic and carcinogens. The contaminants removed by the membranes may also include microorganism, pathogens and particulate nonliving manner not removed by the preliminary filtration substage, and contaminants partly but not entirely removed by the upstream partial-treatment substage. In other words, after the water has been filtered to remove one or more of microorganisms, pathogens, particulate nonliving matter such as ionic dissolved matter, the water is filtered to remove at minimum organic and inorganic matter and smaller ionic dissolved species, and any remaining microorganisms, pathogens and particulate nonliving matter, as fine filtration of the partially treated water. That is, the one or more membranes are configured to remove the finest of particulate matter including bacteria and viruses, and in the case of reverse osmosis which is one example of membrane filtering system, dissolved minerals as well. There are several different scales of membrane filtering from microfilters to reverse osmosis filters, with the latter having the finest membrane filter systems capable of removing ionic species. In the illustrated arrangement, the secondary filtration substage is in series with the preliminary filtration substage 27, collectively forming a filtration substage of the treatment stage. Also, the secondary filtration substage 29 constitutes the final treatment process applied to the water at the treatment stage 20 of the plant 10. However, in alternative arrangements, there may be an ultraviolet irradiation treatment substage downstream from the secondary membrane filtration substage to irradiate the water to ensure all contaminants have been removed.

Thus are formed separate flows of treated water, which is indicated at 32, and contaminated water indicated at 33. Typically, a ratio of volumes of treated water and contaminated water leaving the treatment stage 20 is about 3:1. Therefore, there is a significantly larger proportion of treated water formed as compared to contaminated water from an inflow of untreated water to the treatment stage 20, in other words the raw inflow which is untreated.

After treatment, there is provided a distribution storage stage 35 of the plant 10 in the form of a reservoir between the treatment stage 20 and the user output 17B, which is configured for storing treated water. Since a load of the water distribution/transmission system 4 on the plant 10 is variable, the plant 10 is configured to temporarily store a supply of treated water which can collect at the treatment plant when the demand thereon is low, and which can be delivered to the end users when the demand of the distribution/transmission system 4 is higher than the rate at which treated water is leaving or discharged from the treatment stage 20 (which can be referred to as a treatment stage processing rate, or treatment rate).

To ensure the treatment rate is optimized or maximized, the plant 10 includes the heat transfer assembly 12 which is configured for extracting heat from water downstream from the treatment stage 20 and inputting the extracted heat upstream from the secondary filtration substage 29, so that the membranes thereof may more quickly pass water therethrough for treatment using lower pumping energy or more treated flow for the same pumping energy. In this manner, heat which is carried in the water is not wasted to ambient environment upon leaving the treatment plant 10 as effluent but is recycled within the plant 10.

Consequently, temperature of water flowing through at least the secondary filtration substage 29 is regulated to lie above a minimum threshold temperature for suitable treatment processing and is independent of temperature of the influent at the input 14. Preferably, heated water of a temperature of at least about 20 degrees Celsius, and no higher than about 45 degrees Celsius, flows into the secondary filtration substage 29.

In the illustrated arrangement, the heat transfer assembly 12 is configured to input the extracted heat at least upstream of the preliminary filtration stage 27, or upstream of the partial-treatment substage 23, and preferably upstream of the whole of the treatment stage 20, so that at minimum, physical filtration treatment processes applied to the water and preferably all constituent processes of the treatment stage 20, including chemical and physiochemical, may benefit from an augmented temperature of the water to provide increased respective processing rates.

Since an augmented water temperature may benefit other processes in the treatment plant 10, whether directly treating the water or preprocessing the water for subsequent treatment, the heat transfer assembly 12 of the illustrated arrangement is configured to input the extracted heat immediately downstream of the input 14, so that any stage of the plant 10 downstream from the input 14 receives the heated water. In the illustrated arrangement, the heat transfer assembly 12 is configured to input the extracted heat between the input 14 and the treatment stage 20 which are otherwise in in series fluidic configuration.

To provide sufficient heat for input upstream of at least the secondary filtration substage 29, the heat transfer assembly 12 is configured to extract heat from both the treated water 32 and the contaminated water flows 33. More specifically, the heat transfer assembly 12 comprises a heat transfer loop 38 configured to transport heat using a circulating heat-transfer fluid, such as ethyl alcohol. (Water treatment plant heat pump and heat exchanger fluids must be food grade to protect the treated water; additional design components beyond food grade heat-transfer fluids are totally sealed shell and tube heat exchangers, that is, no gaskets, and higher fluid pressures on the water side to force the water into the food grade heat transfer fluid.) The heat transfer loop 38 comprises a first treated branch 39A configured to extract heat from the treated water flow 32 and a second wastewater branch 39B configured to extract heat from the contaminated water flow 33. Thus, both the treated water and contaminated water are cooled before discharge from the plant 10.

Since the volume and accordingly flow rate of the treated water along 32 is higher than that of the contaminated water along 33, meaning that more heat is available along the treated water flow 32 than from the contaminated flow 33, the heat transfer assembly 12 is configured to circulate heat-transfer fluid at a higher flow rate through the first permeate branch 39A than through the second wastewater branch 39B. A ratio of flow rates of heat-transfer fluid through the first branch 39A and the second branch 39B is greater than or about equal to a ratio of volumes of treated water and contaminated water leaving the treatment stage 20, which typically is about 3:1. The two branches 39A and 39B converge to a common portion of the loop 40 which circulates past a heat transfer device 41 in the form of a heat pump configured to transfer heat from the heat transfer loop 38 to the water for treatment flowing through the plant 10, which is at a lower temperature than the heat transfer fluid before it passes the heat transfer device 41 which is configured to input the extracted heat. A heat transfer device 43 in the form of a sealed, by welding, shell and tube heat exchanger is provided along each branch 39A, 39B configured to passively extract heat from the water downstream from the treatment stage 20. The heat transfer device 43 of the treated branch 39A is located downstream of the reservoir so that the heat transfer assembly is configured to extract heat downstream from the distribution storage stage 35. This may allow the distribution storage stage 35 to act to store thermal energy within the treatment plant 10.

In the illustrated arrangement, the heat transfer assembly 12 is configured to extract heat from the water (after the treatment stage 20 but) before discharge at the output 16.

In view of the cyclical nature of heat movement within the water treatment plant 10, the heat transfer assembly 12 is enabled to begin operating to recycle heat when the temperature of the influent water is at least between about 3 degrees Celsius and about 5 degrees Celsius, without inadvertently affecting discharge of water from the plant, either to sewer 3 or distribution/transmission 4. For the heat pump system to start the heating process, the 3 to 5 degrees Celsius influent temperature is required to allow the heat pump to remove 1 to 2 degrees Celsius from the influent water and move this heat to the output water. The practical approach would be to start the process before winter water temperatures are present or provide a few days of preheating using a natural gas or propane heating system to raise the temperatures to at least 3 degrees Celsius.

During steady state operation, the temperature of the influent water may be below the minimum start-up temperature as described above yet still above freezing (0 degrees Celsius). In an example where the water at the input 14 is about 3 degrees Celsius, the heat transfer assembly 12 can, over a period of several days, increase the temperature of the water to be treated by about 25 degrees Celsius so that the temperature of the water admitted to the treatment stage 20 is about 28 degrees Celsius after passing the heat pump 41.

The treatment stage 20 does not significantly alter the temperature of the water flowing therethrough such that both the flows of the treated water 32 and the contaminated water 33 substantially remain at the temperature of the heated untreated water upstream of the treatment stage 20, which is about 28 degrees Celsius.

Each of the heat transfer branches remove about 23-25 degrees Celsius of heat from the water before discharge at the output 16, for subsequent transfer to the water for treatment. The food grade heat-transfer fluid may operate at temperatures above and below 0 degrees Celsius and thus is adapted not to freeze for a prescribed temperature range below the freezing point of water (for example, fresh water). Also, the heat pump 41 may add about 1 to 2 degrees Celsius of heat to the system from the electrical/mechanical operation of the heat pump.

Thus there is disclosed herein an arrangement for extracting heat from strategic locations in a water treatment plant and recycling the heat to an input of a treatment substage, particularly before treatment at the secondary filtration substage, to improve performance of the membrane(s) thereof. This recycling of heat will also reduce power consumption for pumping water through one or more of the filtration substages or increase the processing rate of the treatment process.

There is also disclosed herein a method for treating water comprising:

receiving water to be treated at the input 14;

applying one or more chemical or physiochemical processes to partially treat the water, at the partial-treatment substage 23;

filtering the water to reduce content of at least one of microorganisms, pathogens and particulate matter, at the preliminary filtration substage 27;

after filtering the water to reduce the content of at least one of microorganisms, pathogens and particulate matter, filtering, at the secondary filtration stage 29 comprising membranes, the water to remove substantially all remaining contaminants including organic and inorganic matter and preferably also ionic species;

whereby separate flows of treated water and contaminated water are formed at 32 and 33;

temporarily storing the treated water at the distribution storage stage 35;

discharging the treated and contaminated waters at the output 16; and

before discharging the treated and contaminated waters, extracting heat therefrom and inputting the heat to the water before filtering the water to remove organic and inorganic matter using the heat transfer assembly 12.

Moreover, as described hereinbefore, the present invention relates to a water treatment plant and related method of water treatment comprising a treatment stage which includes a partial-treatment substage configured to apply at least one of chemical and physiochemical processes for reducing contaminants in the water, a preliminary filtration substage configured to remove large contaminants in the water such as microorganisms and pathogens, and a secondary filtration substage comprising one or more selectively permeable membranes configured to remove organic and inorganic matter, any remaining bacterial and viral microorganisms and potentially ion species from the water. The plant also includes a heat transfer assembly configured to extract heat from water downstream of the treatment stage and to input the heat to water to be treated upstream of at least the secondary filtration substage, so as to recycle heat in the water within the plant to increase a treatment rate or reduce the power consumption of at least the secondary filtration substage.

The scope of the claims should not be limited by the preferred embodiments set forth in the examples but should be given the broadest interpretation consistent with the specification as a whole.

1. A water treatment plant comprising:
an input configured for receiving water for treatment;
an output configured for discharging water after treatment, wherein the output comprises a sewer output configured for discharging contaminated water to sewer and a user output configured for discharging treated water for user consumption;
wherein a flow of water is defined by the input and the output;
a treatment stage between the input and the output and configured for reducing contaminants in the water, wherein the treatment stage is configured to form treated water, which is substantially free from contaminants, and contaminated water;
wherein the treatment stage includes:
a partial-treatment substage configured for applying at least one of chemical and physiochemical processes to reduce the contaminants in the water;
a preliminary filtration substage configured for reducing contaminants including at least one of microorganisms, pathogens and particulate nonliving matter;
a secondary filtration substage downstream from the preliminary filtration substage, relative to the flow of water, and comprising a selectively permeable membrane configured for mechanically removing substantially all remaining contaminants not removed by the partial-treatment or preliminary filtration substages;
a distribution storage stage between the treatment stage and the user output and configured for storing treated water; and
a heat transfer assembly configured for extracting heat from water downstream from the treatment stage and inputting the extracted heat upstream from the secondary filtration substage.

2. The water treatment plant of claim 1 wherein the heat transfer assembly is configured to input the extracted heat upstream of the preliminary filtration stage.

3. The water treatment plant of claim 1 wherein the heat transfer assembly is configured to input the extracted heat upstream of the treatment stage.

4. The water treatment plant of claim 1 wherein the heat transfer assembly is configured to input the extracted heat immediately downstream of the input.

5. The water treatment plant of claim 1 wherein the heat transfer assembly is configured to extract heat downstream from the distribution storage stage.

6. The water treatment plant of claim 1 wherein the heat transfer assembly is configured to extract heat from the treated water and the contaminated water.

7. The water treatment plant of claim 6 wherein the heat transfer assembly comprises a heat transfer loop configured to transport heat using a circulating heat-transfer fluid and wherein the heat transfer loop comprises a first branch configured to extract heat from the treated water and a second branch configured to extract heat from the contaminated water, and wherein the heat transfer assembly is configured to circulate heat-transfer fluid at a higher flow rate through the first branch than through the second branch.

8. The water treatment plant of claim 7 wherein a ratio of flow rates of heat-transfer fluid through the first branch and the second branch is greater than or about equal to a ratio of volumes of treated water and contaminated water leaving the treatment stage.

9. The water treatment plant of claim 7 wherein the ratio of flow rates of heat-transfer fluid through the first branch and the second branch is greater than or about 3:1.

10. A method for treating water comprising:
applying one or more chemical or physiochemical processes to partially treat the water;
filtering the water to reduce contaminants including at least one of microorganisms, pathogens and particulate matter;
after filtering the water to reduce at least one of microorganisms, pathogens and particulate matter, filtering the water to remove substantially all remaining contaminants;
whereby separate flows of treated water and contaminated water are formed;
temporarily storing the treated water;
discharging the treated and contaminated waters; and
before discharging the treated and contaminated waters, extracting heat therefrom and inputting the heat to the water before filtering the water to remove organic and inorganic matter.
